(19) United States
(12) Patent Application Publication
(10) Pub. No.: US 2016/0140676 A1
(43) Pub. Date: May 19, 2016

(54) VISUALIZATION TOOL FOR FURNITURE ARRANGEMENT IN A REAL ESTATE PROPERTY

(71) Applicant: DIAKRIT INTERNATIONAL LTD., Hong Kong (CN)

(72) Inventors: Martin FRITZE, Knäred (SE); Dick KARLSSON, Värmdö (SE); Fredrik BERGMAN, Mellbystrand (SE); Matthew CAMPBELL, Bangkok (TH)

(73) Assignee: DIAKRIT International Ltd., Hong Kong (CN)

(21) Appl. No.: 14/900,003

(22) PCT Filed: Jun. 17, 2014
(86) PCT No.: PCT/SE2014/050740

§ 371 Date: Dec. 18, 2015

Related U.S. Application Data
(60) Provisional application No. 61/837,590, filed on Jun. 20, 2013.
(60) Provisional application No. 61/843,033, filed on Jul. 4, 2013.

(51) Int. Cl. G06Q 50/16; G06F 3/0484; G06Q 30/06

(52) U.S. Cl. CPC G06Q 50/16; G06Q 30/0643; G06F 3/04842; G06F 3/04847

(57) ABSTRACT

The present disclosure relates to a system, method and computer-readable storage medium having computer-executable instructions for providing interactive visualization of furniture arrangement in a real estate property to potential customers via a computer interface environment. The system comprises the visualization engine is which is adapted to allow a potential customer to select items and process items to be inserted within the visualization object.

### CROSS REFERENCE TO RELATED APPLICATIONS

This application is a U.S. National Stage patent application of PCT/SE2014/050740, filed on Jun. 17, 2014, which claims priority to U.S. Patent Application No. 61/837,590, filed on Jun. 20, 2013, and U.S. Patent Application No. 61/843,033, filed on Jul. 4, 2013 and the entire contents of which are incorporated herein by reference.

### FIELD OF THE INVENTION

The present disclosure relates to a system, method and computer-readable storage medium having computer-executable instructions for providing interactive visualization of furniture arrangement in a virtual real estate property to potential customers via a computer interface environment. The system comprises the visualization engine is which is adapted to allow a potential customer to select items and process items to be inserted within the visualization object.

### BACKGROUND OF THE INVENTION

Conventional advertising mediums for the sale of real estate include newspapers, magazines, print, television, radio, internet and other forms of media channels to provide advertising to the general public. The internet is one of the most common and successful forms of advertising currently used, and the form that growths faster than any other form of advertising. Typically and traditionally, a private seller approaches a real estate agent to sell his or her piece of property, and the real estate agent then advertises the property on its own and/or a third party's website, as well as possibly engaging in some of the other forms of advertising and promotion mentioned above. Potential buyers can then easily scan properties for sale via these websites, and if the potential buyer considers one object particularly attractive, he can study the details of the advertising and contact the real estate agent for more information.

Construction companies that plan, finance, build and advertise their objects, such as apartment blocks or residential areas of townhouses and houses, use similar methods, despite their size, when advertising their objects. In particular the planning and financing parts of such a construction project are highly dependent on the perceived market interest. Therefore, it is essential for the risk assessment of a major residential construction project, as early as possible during the project, to get a clear understanding of the market and of future interest in the real estate objects to be sold. As mentioned, currently the fastest growing advertising channel is the internet. There are many methods employed on internet websites to tempt the viewer to be interested in a particular real estate object for sale. For example, photos of the real estate, virtual tours, or data and information that can be compared between similar and comparable real estate objects all provide enticers for the potential buyer. Numerous providers of information related to the sale of real estate exist and the competition between them is fierce. The recent prevalence of the internet has greatly influenced the ability for potential customers to stay aware of what is available on the real estate market. It has also significantly increased their ability to access information necessary to make informed investment decisions. Key features for successful internet real estate advertising are professional exterior and interior photographs taken by skilled photographers. Moreover, object descriptions need to be written by talented editors and the overall visual impression requires high-quality imagery.

Just a few years ago, the only computing platform from where a user could access the internet was the desktop computer or laptop computer. However, today there are numerous computers other than desktop computers and laptop computers from where the internet is also accessible. These computers include smart phones, tablet computers, “pad” computers and even so-called SMART-TVs. A user of the internet takes for granted that an internet website is available from any computing platform. A smart phone, typically with a small touch screen, compared with a large, high-resolution computer screen offer diverse conditions for visualizing objects. Today, a frequent user of the internet is used to having access to the internet anywhere and anytime. This user is also expecting applications (apps) and content to be available irrespective of the platform currently in use and the media content to be adapted to the conditions offered for visualization by the particular platform.

International patent application WO 2004/019170 discloses a system for generating a manufacturing process for producing at least one assembly. The system includes a processor, computer software to implement the method, and optionally internet web-pages that allow a remote user to design an assembly and submit the assembly to a manufacturer who will then be able to produce the assembly by following the manufacturing process defined by the identifier of each component and the manufacturing methodology or methodologies for each contact area. However, the disclosed system does not relate to, or in any way influence, general interest from the market or feedback from potential customers relating to a residential construction project during the initial exploration phases.

US patent application 2012/0066074 discloses a portal for use as a node between stakeholders in real estate transactions. Information is provided to support transactions with various real-estate related goods and services, such as paint companies, furniture companies, or landscaping companies to potential real estate buyers. It may also allow manufacturers or sellers of good such as furniture to advertise on the platform. Additionally, furniture items available from the manufacturer may be selected and inserted into a photo image of the property being viewed. For example, a link to a furniture manufacturer may showcase furniture items to be added to the image of the photo image of a room.

A global trend is urbanization. Cities tend to offer opportunities for people that are not available in less urbanized areas, irrespective of whether the opportunities are related to presence of family and relatives, education, work or professional development, cultural events or entertainment. A consequence of the urbanization is higher pressure on the housing market from all the people that move into the cities from smaller communities or from the country side. In particular young people suffer from the lack of affordable places to live, and often have to commute long distances to get to their schools or to work. Despite the apparent need for an increase in the number of newly constructed apartments and houses, the typical situation is that fewer new real estate objects are built than the actual need. This has led to a situation in which the pressure on the real estate market in urban areas seems to be ever increasing.

In accordance with the previous explanation, a construction company that faces a decision whether to start a major residential area construction project, in early stages of the project needs to get feedback from the market about its perceived attractiveness. Positive feedback is necessary for the company to assess the financial exposure and mitigate the business risk. A problem associated to the above situation is that the time from early stages of planning to the actual date of occupancy in an apartment or a house may be several years long. That time span influences the business risk significantly, and further reduces the tendency to start major construction projects, despite the apparent need.

### SUMMARY OF THE INVENTION

It is therefore an object of the resent invention to alleviate the shortcomings of prior art technology. This object is achieved by means of a system, a computer-implemented method and a non-transitory computer-readable storage medium for providing interactive visualization of furniture arrangement in a real estate property to potential customers via a computer interface environment, the system comprising: a computer memory having a computer database in which drawings or images transformed into objects are stored, and one or more computer processors operatively coupled to the computer memory, wherein the one or more computer processors are controlled by a service provider, the one or more computer processors comprising a reader, a visualization engine and user interaction engine, wherein the reader is adapted to read at least one visualization object from the computer memory, the visualization engine is adapted to provide, via the computer interface, a potential customer with the at least one visualization object in response to the potential customer's activation, upon which a particular visualization object is displayed, characterized in that the visualization engine is further adapted to allow the potential customer to select items and process items to be inserted within the visualization object.

In some embodiments, computer-enabled tools to allow construction companies to better assess the financial exposure and mitigate the business risk involved in the construction of residential areas. In some embodiments, potential customers of real estate properties are provided with computer-enabled tools to create the best possible basis for a decision whether or not to register an expression of interest in a particular property.

Embodiments of the computer-enabled tools provide interactive visualization of furniture arrangement in a real estate property to potential customers via a computer interface environment. For example, in one embodiment, the computer-enabled tools include a graphical user interface provided by a system that comprises a computer memory having a computer database on which drawings or images transformed into objects are stored, and one or more computer processors operative coupled to the computer memory, where the one or more computer processors are controlled by a service provider, the one or more computer processors comprising a reader, a visualization engine and user interaction engine. The reader is adapted to read at least one visualization object from the computer memory, the visualization engine is adapted to provide, via the computer interface, potential customers with the at least one visualization object in response to their activation, upon which a particular visualization object is displayed. The system is characterized in that the visualization engine is further adapted to allow the potential customer to select items and process items to be inserted within the visualization object. Advantageously, the system enables potential customers to experience and compare a real estate object for sale without physically being in contact with the object. It is conceivable that the potential customer is able to examine a property with furniture according to his or her personal preference and financial capacity. This examination may take place long before construction of the particular real estate property object has begun and possibly even before definitive decisions on whether to realize the object have been made.

Beneficially, the system also provides a construction company with feedback from the market via potential customers at an early stage. Plausible is that some customers will be placing orders and advanced payments early on in a purchase process when they have been provided with tools that enable realistic visualizations of a fully furnished object as a basis for informed investment decisions.

In accordance with one embodiment of the present disclosure, selected items are digitalized construction drawings, so as to allow for any type of image processing, such as ability to rotate, scale, move, colorize or delete items. This would not be possible had the items been photo images but is possible due to the digitalized construction drawings made of each single item, such as each single piece of furniture.

In accordance with another related embodiment of the present disclosure, the selected items are scale models of real pieces of furniture available for purchase by selected furniture providers. An important benefit related to this feature is that potential customers are allowed to furnish their virtual future homes with pieces of furniture that are actually available for purchase on the market. This gives the potential customers a further sense of security when choosing their next residence, a choice that oftentimes exposes the potential customer with a financial risk of relative size compared to other consumer durables. Changing the place to live often means a major change in life and lifestyle, which is connected to certain anxiety anyway.

In accordance with another and also related embodiment, the visualization objects and selected items are displayable in two-dimensional or three-dimensional representation. This further enhances the potential customer's ability to fully and concretely visualize and understand a real estate property object. In order to further strengthen the potential customer's ability to connect to a property for sale, the processing of items include the mentioned ability to rotate, scale, move, colorize or delete items. With reference to yet another embodiment, the selection and processing of items is connected to a list of items and their place of purchase, price and/or availability to be displayed to the potential customer. This simplifies for the potential customer the process of finding and purchasing items with which the property has been virtually furnished. It also creates a mutually valuable platform for integrated partnerships between service providers of the described visualization tool and for example suppliers of furniture and decorations for household use.

In accordance with another exemplary embodiment of the present disclosure, the server being controlled by the service provider is adapted to respond to the platform in use by a potential customer, and adapt the provided visualization object thereto. Hereby is achieved that the potential customer is always provided with information regarding the object of interest, an object that is optimally displayed with respect to the platform presently in use by the customer.

By means of the present disclosure, users are allowed to furnish several floor plans in different layers as well as make modifications of existing design and decoration. This is enabled by means of features of the computer-enabled tools here described, that provide users and potential buyers with interactive visualization of furniture arrangement in a real estate property of possible present or future interest.

### BRIEF DESCRIPTION OF THE DRAWINGS

FIG. 1 illustrates an exemplary system for providing interactive visualization of furniture arrangement in a real estate property according to the present disclosure.

FIG. 2 is a flow chart of an exemplary process for providing an interactive visualization. FIG. 3 is a front view of an exemplary user interface for providing interactive visualization of furniture arrangement in a real estate property.

### DETAILED DESCRIPTION OF THE INVENTION

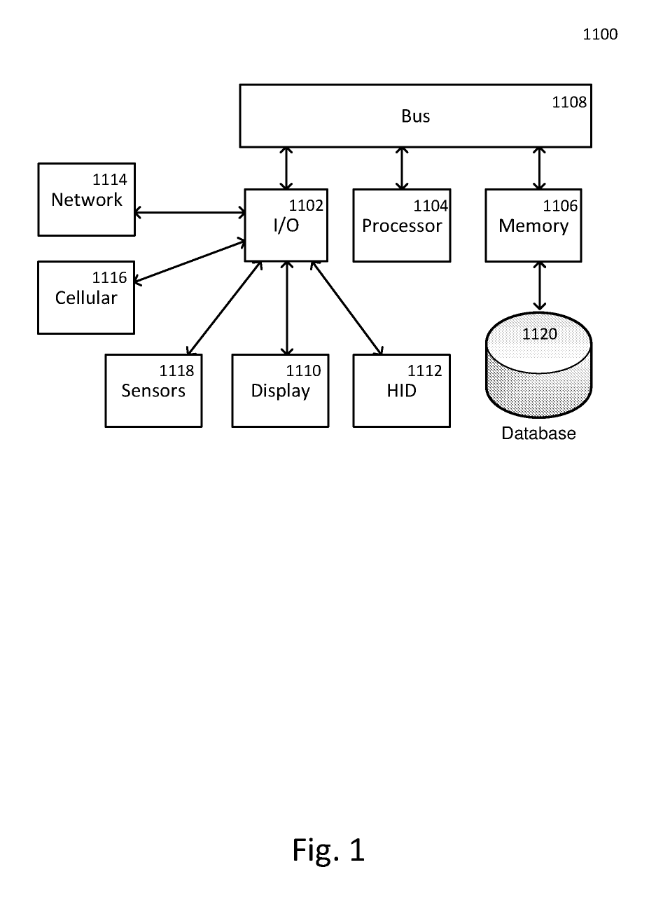

The embodiments disclosed herein include a computer-enabled visualization tool that provides a graphical user interface by which a potential customer is able to realize furniture set-up in a virtual real estate property. With scalable measurement functions and a large range of furnishings and interior details, the visualization tool allows for furniture arrangement in a virtual real estate property. By using the visualization tool, the potential customer is presented with is an experience that strengthens the decision-making process. By allowing potential customers to furnish, decorate, rotate, adjust and navigate, the potential possibilities of a property can be visualized. The furniture arrangement feature, and more generally, the visualization tool are interactive and user-friendly and thus offer a strong and natural complement to floor plans that considerably enhances real estate property marketing by strengthening, and thereby also shortening, the decision-making process. FIG. 1 illustrates an exemplary computing system 1100 for implementing one or more of the features and/or processes of the computer-enabled visualization tool described herein, for example process 1200, described below. The computing system 1100 may be a computer such as a desktop computer, a laptop computer, a smart phone, a tablet computer, a “pad” computer, SMART-TV, or the like. As shown in FIG. 1, computing system 1100 comprises a motherboard with bus 1108 that connects I/O section 1102, one or more computer processors 1104, and a memory section 1106 together. The I/O section 1102 may be connected to display 1110, input device 1112, which may be a touch-sensitive surface, one or more buttons, a keyboard, a mouse, or the like. I/O section 1102 may also be connected to network interface 1114, cellular antenna 1116 and/or sensors 1118. Memory section 1106 may be a solid-state memory or a computer-readable medium that stores (e.g., tangibly embodies) one or more computer programs for performing processes of the computer-enabled visualization tool described herein using computer processor(s).

Computer programs stored in memory 1106 may be written, for example, in a general-purpose programming language (e.g., C including Objective C, Java, JavaScript including JSON, and/or HTML including HTML5) or some specialized, application-specific language. By means if its cross-device compatibility, platform independent and highly responsive design, buyers, renters and other stake holders on the real estate market can easily choose from a large variety of objects and models to digitally furnish and decorate properties online. All presently available operative systems and web browsers are easily made compatible with the visualization tool according to the disclosure, due to the platform independence. Any known web browser of today, such as for example Chrome, Safari, Internet Explorer and FireFox, is fully compatible with the service.

Also, some values based on the results of the features and/or processes described herein can be saved into memory such as memory 1106 for subsequent use. For instance, memory section 1106 may contain a computer database 1120 for storing real estate property information, such as visualization objects related to real estate properties. In the database 1120 may also be stored general models of furniture or models of real pieces of furniture available for purchase, by which a potential customer is allowed to virtually furnish a real estate property of interest.

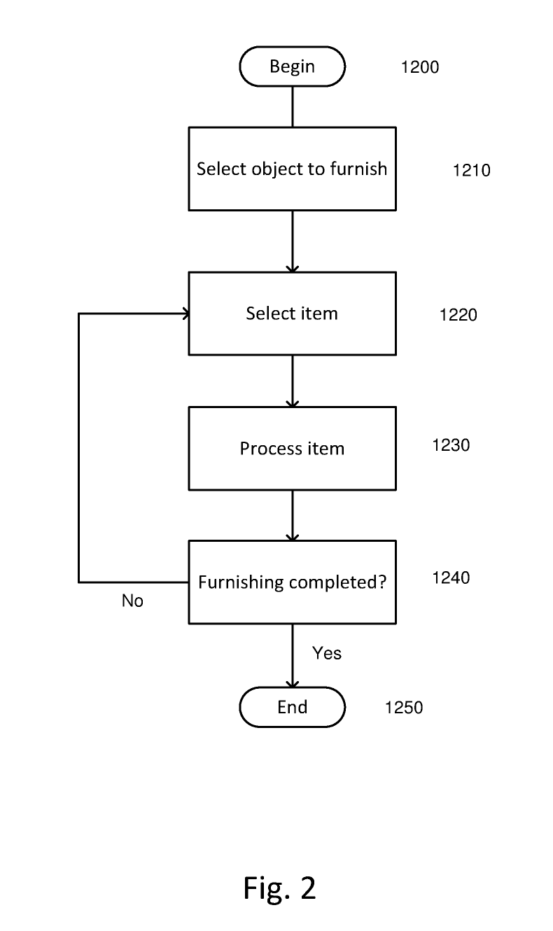

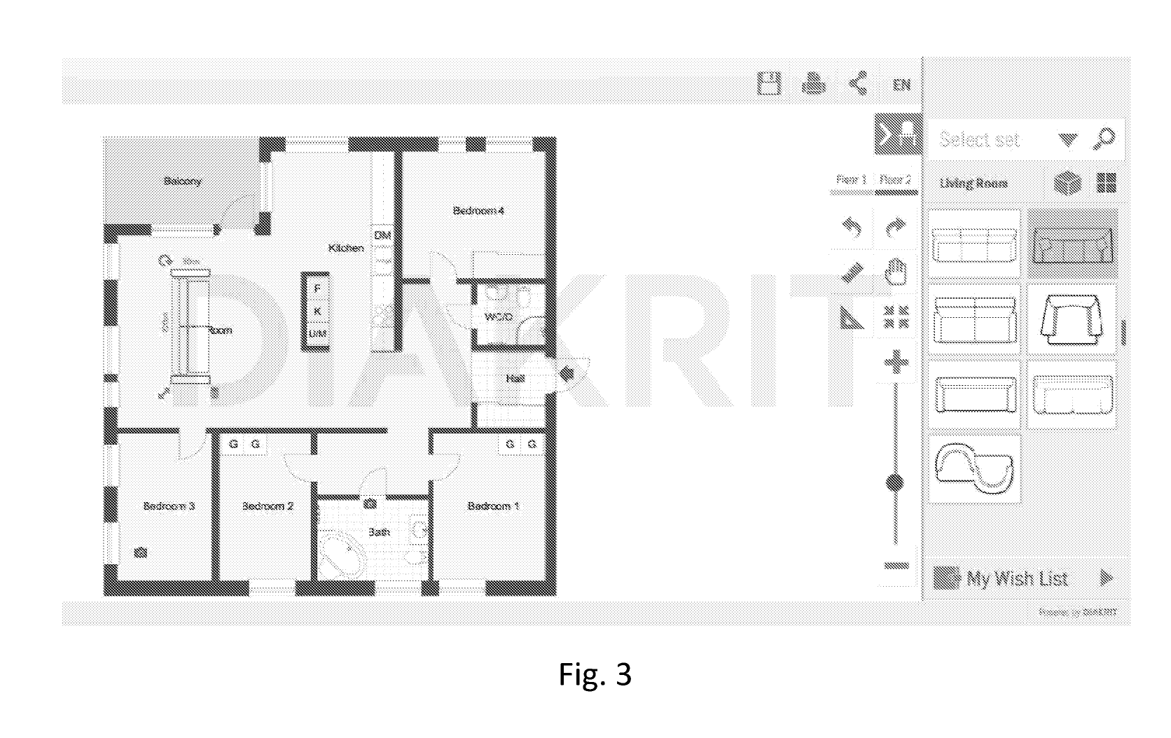

FIG. 2 illustrates a flow chart of method steps in the exemplary process 1200 for providing an interactive visualization of partly or completely furnished real estate properties. At block 1210, the potential customer is provided with a selection of objects to choose from. The selection may either be a selection of models representing general pieces of furniture or a selection models representing furniture available for purchase from different furniture manufacturers. An item is selected at block 1220 by the potential customer and further processed at block 1230. This further processing may entail highlighting a particular item and virtually moving it to a room or a place in a floor plan where it seems to fit in well. The processing continues in that the potential customer is allowed to rotate, adjust, re-size, change colors and move the item from one place to another. This continues until the potential customer is satisfied with the result and chooses to complete the furnishing procedure at block 1240. He or she is then given the opportunity to end the process and save the result. Optionally, upon user request, a list of data may be displayed relating to price, availability and place of purchase of the particular furniture items chosen. The entire process has the effect to the potential customer of giving a lifelike visualization of all potential possibilities of a real estate property as early as long before the actual property has been built.

1. A system for providing interactive visualization of furniture arrangement in a real estate property to potential customers via a computer interface environment, the system comprising:
a computer memory having a computer database in which drawings or images transformed into objects are stored, and
one or more computer processors operatively coupled to the computer memory,
wherein the one or more computer processors are controlled by a service provider, the one or more computer processors comprising a reader, a visualization engine and user interaction engine,
wherein the reader is adapted to read at least one visualization object from the computer memory, and the visualization engine is adapted to provide, via the computer interface, a potential customer with the at least one visualization object in response to the potential customer's activation, upon which a particular visualization object is displayed, and
wherein the visualization engine is further adapted to allow the potential customer to select items and process items to be inserted within the visualization object.

2. The system of claim 1, wherein the selected item is displayed in within the visualization object as an additional layer on top of the visualization object layer.

3. The system of claim 1, wherein the selected items are digitalized construction drawings.

4. The system of claim 1, wherein the selected items are scale models of general pieces of furniture.

5. The system of claim 1, wherein the selected items are scale models of real pieces of furniture available for purchase by selected furniture providers.

6. The system of claim 1, wherein the visualization objects and selected items are displayable in two-dimensional or three-dimensional representation.

7. The system of claim 1, wherein the processing of items include the ability to rotate, scale, move, colorize or delete items.

8. The system of claim 1, wherein the selection and processing of items is connected to a list of items and their place of purchase, price and/or availability to be displayed to the potential customer.

9. The system of claim 1, wherein a saved adjustment or modification to a floor plan, including furniture and decoration, generates a new and unique uniform resource locator (URL).

10. The system of claim 1, wherein the computer memory and/or computer database in control by the service provider are adapted to respond to a platform in use by a potential customer, and adapt the provided visualization object thereto.

11. The system of claim 10, wherein the adaptation is based on header information provided to the visualization engine from the platform from which information the responsiveness of the visualization engine can be controlled.

12. The system of claim 1, wherein the visualization engine is realized in a common language which is readable and executable for desktops, tablets and smart phones, such as HTML5.

13. A computer-implemented method for providing interactive visualization of real estate properties to potential customers via a computer interface, the method comprising:
storing drawings or images transformed into objects in a database in a computer memory,
reading, by one or more computer processors, at least one visualization object from the database,
wherein the one or more computer processors are controlled by a service provider and provide a visualization engine and a user interaction engine, providing, via a computer interface, a potential customer with the at least one visualization object in response to the potential customer's activation, upon which a particular visualization object is displayed, and
wherein the at least one visualization objects are displayed dynamically in a variety of different views.

14. A non-transitory computer-readable storage medium having computer-executable instructions, wherein the computer-executable instructions, when executed by one or more computer processors, cause the one or more computer processors to provide interactive visualization of real estate properties to potential customers via a computer interface, the computer-executable instructions comprising instructions for:
storing drawings or images transformed into objects in a database in a computer memory, and
reading at least one visualization object from the database, wherein the reading is controlled by a service provider, causing the computer interface to provide a potential customer with the at least one visualization object in response to the potential user's activation, upon which a particular visualization object is caused to be displayed,
wherein the at least one visualization objects are displayed dynamically in a variety of different views.
